(19) United States
(12) Patent Application Publication
(10) Pub. No.: US 2002/0152668 A1
(43) Pub. Date: Oct. 24, 2002

(54) Superelastic fishing rod

(76) Inventor: Michael A. Lybarger, Broken Arrow, OK (US)

Correspondence Address: FELLERS SNIDER BLANKENSHIP, BAILEY & TIPPENS, THE KENNEDY BUILDING, 321 SOUTH BOSTON SUITE 800, TULSA, OK, 74103-3318, US

(21) Appl. No.: 09/838,350

(22) Filed: Apr. 19, 2001

(51) Int. Cl. A01K 87/00

(52) U.S. Cl. 43/18.1

(57) ABSTRACT

A fishing rod comprising an elongate rod having at least a longitudinal portion thereof formed of a superelastic material selected from the group consisting of superelastic metals and superelastic metal alloys.

### FIELD OF THE INVENTION

The present invention relates to fishing rods which are formed, in whole or in part, from superelastic metals or superelastic metal alloys.

### BACKGROUND OF THE INVENTION

Efforts continue in the art to develop fishing rods which provide better performance, balance, feel, and comfort. A need particularly exists for fishing rods which provide such improvements while being both lightweight and highly durable. Moreover, a need exists for improved fishing rods which will not break or become permanently deformed even when exposed to extreme accidental bending loads or deflections. Such loads and deflections can occur, for example, if the end of the rod becomes caught in a tree or bush when carrying or if the rod becomes caught in or under shifting cargo during transport.

### SUMMARY OF THE INVENTION

The present invention provides a fishing rod which satisfies the needs and alleviates the problems discussed above. The inventive fishing rod comprises an elongate rod having at least a longitudinal portion thereof formed of a superelastic material selected from the group consisting of superelastic metals and superelastic metal alloys. The inventive rod can also comprise at least one line guide, on the elongate rod, formed of either a superelastic metal or a superelastic metal alloy. The superelastic material will preferably be a shape memory material and will most preferably be a nickel-titanium alloy.

The inventive rod is highly durable and resistant to breakage. Moreover, in contrast to prior high durability rods, the inventive rod is lightweight and provides significantly improved balance, feel, comfort, performance, and sensitivity to strikes and line play. The inventive reel can be adapted to provide generally any desired stress resistance and flexing characteristics for all conditions and loads encountered when fishing. At the same time, however, the superelastic material employed in the inventive rod will yield to extreme accidental loads such as those which may be encountered when carrying or transporting the rod, and then return to its original shape when the accidental load is removed.

Further objects, features, and advantages of the present invention will be apparent to those skilled in the art upon examining the accompanying drawing and upon reading the following description of the preferred embodiments.

### BRIEF DESCRIPTION OF THE DRAWING

FIG. 1 schematically illustrates an embodiment 2 of the fishing rod provided by the present invention.

FIG. 2 illustrates a side-by-side comparison of the elastic recovery characteristics of various rod materials.

### DETAILED DESCRIPTION OF THE PREFERRED EMBODIMENTS

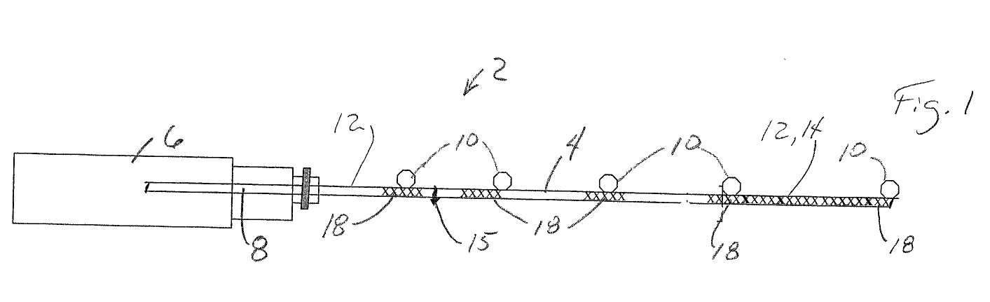

An embodiment 2 of the inventive fishing rod is depicted in FIG. 1. Inventive fishing rod 2 comprises: an elongate rod 4; a handle and grip structure 6 received over or otherwise attached to the proximal end 8 of elongate rod 4; and a plurality of line guides 10 attached to or secured on the top of rod 4.

If desired, elongate rod 4 can be a one-piece structure composed entirely of a superelastic material of the type described hereinbelow. Alternatively, rod 4 can be formed of two or more elongate segments 12 which are either permanently attached or removably attachable to each other. When a plurality of elongate segments 12 are employed, one, all, or any combination of the elongate segments can be formed of a superelastic material of the type described hereinbelow. Any remaining segments 12 of the rod 4 can be formed from either a different superelastic material or generally any other type of material used heretofore for forming fishing rods. Examples of such other materials used heretofore for producing fishing rods include, but are not limited to, composites, metal, wood, graphite, and plastics.

For an elongate rod 4 having a plurality of elongate segments 12, the individual segments 12 can be removably attachable to each other using ferrules, collars, threads, twist locks, interface fits, or generally any other type of mechanical fittings or couplings known in the art. Such fittings or couplings can be attached to or integrally formed in the ends of the rod segments 12. Alternatively, the individual rod segments 12 can be permanently attached to each other by adhesive bonding or a combination of adhesive bonding and mechanical attachment. It will be further understood by those skilled in the art that, if elongate rod 4 comprises three or more elongate segments 12, some of the segments 12 could be permanently attached to each other with the remaining segment(s) 12 being removably attachable.

It will also be understood by those skilled in the art that the inventive fishing rod 2 can be adapted for any type of use and style of fishing. Thus, inventive fishing rod 2 could be a generic rod, a crappie rod, a spinning rod, a casting rod, a trigger rod, a bass rod, a trout rod, a muskie rod, or generally any other type of rod used in the art. To accommodate these different uses, the elongate rod 4 can be a one-piece unitary rod or can be formed of any number of elongate segments 12 as discussed above. Moreover, rod 4 and/or the individual segments 12 thereof can be of any desired length, can be of any desired cross-sectional shape (e.g., round, hex, etc.), and can be tapered or of constant diameter. Further, rod 4 and/or the individual elongate segments 12 thereof can be of solid construction or hollow.

Inventive fishing rod 2 will preferably comprise at least an elongate distal end segment (i.e., a “rod tip”) 14 formed of superelastic material. As used herein and in the claims, the terms “distal end segment” and “rod tip” refer to the outermost elongate segment 12 of rod 4. Rod tip 14 can be of any desired length and can be removably or permanently attached at any desired point 15 outside of handle 6.

For further protection against breakage, any or all of the line guides 10 provided on elongate rod 4 can be formed of a superelastic material of the type described hereinbelow. As will be understood by those skilled in the art, line guides 10 can be secured on rod 4 by winding string or thread 18 over the foot pieces of line guides 10 and applying a synthetic resin material thereto. Alternatively, the line guides 10 can be attached by gluing or by any other approach used in the art for securing line guides on fishing rods. In a particularly preferred embodiment of the present invention, at least the line guide(s) 10 provided on the rod tip segment 14 of fishing rod 2 will be formed of a superelastic material.

The superelastic material employed in the present invention can generally be any metal or metal alloy which will provide sufficient superelasticity over the range of ambient temperatures in which inventive fishing rod 2 will be used such that the superelastic segment(s) 12 of elongate rod 4 (a) will flex or bow in response to loads experienced when fishing, without yielding or breaking, in a manner similar to that of other types of fishing rods but (b) will yield and bend in response to extreme loads which might be experienced, for example, if the end of rod 4 becomes caught when carrying or if the rod becomes caught in or beneath shifting cargo during transport.

As used herein and in the claims, the terms “superelastic” and “superelasticity” refer to a resiliency arising from the formation and reversion of stress-induced phase transformations characterized by a crystal lattice distortion.

The superelastic material employed in inventive fishing rod 2 will preferably be a nickel-titanium alloy. The composition of the alloy, the manner in which the material is processed, and ambient temperature are known to affect the superelastic properties of nickel-titanium compositions. However, it is well within the skill of those in the art to produce an alloy and rod having the characteristics desired for the present invention. In this regard, reference is made to U.S. Pat. Nos. 4,895,438 and 5,637,089, whose disclosures are incorporated herein in their entirety. The '438 patent, for example, discloses a method of fabricating an “optimized elastic” alloy exhibiting superelasticity over a particularly desirable range of temperatures extending from about −25° C. to about 40° C.

A nickel-titanium alloy particularly preferred for use in inventive fishing rod 2 is commonly referred to by the acronym NITINOL which stands for Nickel Titanium Naval Ordinance Laboratory. NITINOL exhibits two desirable, unique properties; superelasticity and “shape memory.” Shape memory refers to the ability to restore the original shape of a plastically deformed material by heating the material to achieve a crystalline phase change known as “thermoelastic martensitic transformation.” Below its transition (or transformation) temperature, NITINOL has a soft “martensitic” microstructure which is deformable. Heating the material converts it to its high strength, austenitic state. The transformation to and from the two states can be repeated by subjecting the material to alternating heating and cooling cycles.

The superelastic effect, on the other hand, is achieved when the alloy is subjected to stress in a temperature range above its transition temperature. Such stress results in the temporary conversion of a portion of the material to its martensite state. However, because the martensite has been formed above its normal temperature, it quickly reverts (i.e., springs back) to its undeformed, austenitic state as soon as the stress is removed.

The nickel-titanium alloy employed in inventive fishing rod 2 will preferably have a transition temperature (i.e., an austenitic finish temperature) in the range of from about −30° C. to about −20° C. (most preferably about −25° C.) and will preferably exhibit superelasticity throughout the temperature range extending from about −25° C. to about 40° C. The superelastic material will most preferably be a NITINOL alloy comprising or consisting essentially of from about 55 to about 56 parts by weight nickel and from about 44 to about 45 parts by weight titanium.

Depending upon the particular characteristics required, the composition of the nickel-titanium alloy can be varied and/or other additives can be included. Excess nickel can be used to depress the transition temperature and increase the yield strength of the alloy. A small amount of iron could be added to lower the transition temperature of the material. A small amount of chromium could be included to decrease the hysteresis and lower the deformation stress of the martensite. The addition of platinum, palladium, cobalt, vanadium, aluminum, copper, or a combination thereof in an amount in the range of from about 0.1 to about 2.0% by weight, based on the total weight of the alloy, can be used to adjust the transformation temperature of the alloy to generally any desired value in the range of from about −120° to about 20° C.

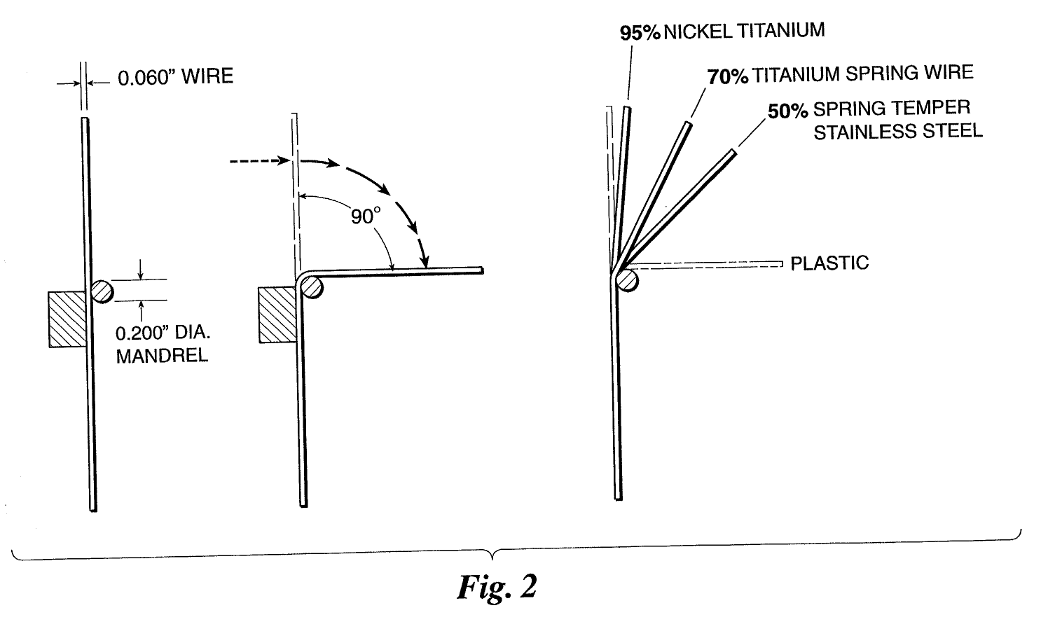

A comparison of the desirable characteristics and behavior of a NITINOL alloy as compared to stainless steel and titanium is depicted in FIG. 2. When a 0.06 inch diameter cylindrical wire formed of each type of material is bent at a 90° angle around a 0.200 inch diameter cylindrical mandrel, the nickel-titanium wire exhibits an elastic recovery percentage of approximately 95% as compared to 50% for stainless steel and 70% for a titanium spring wire. (As used herein and in the claims, all references to elastic recovery values refer to the properties exhibited when wrapping a 0.06 diameter cylindrical length of the superelastic material around a 0.200 inch diameter cylindrical mandrel.) The present invention thus provides an inventive rod 4 and/or rod segment 12 possessing an elastic recovery percentage which exceeds 50% and preferably exceeds 90%.

The elastic limit of the superelastic material refers to the degree to which a 0.06 inch diameter cylindrical wire may be strained without incurring permanent deformation. A stainless steel wire will permanently deform when subjected to, at best, a four-tenths percent (0.4%) strain. This means that, should the wire be stressed (e.g., pulled) so as to incur more than 0.4% strain (e.g., elongation) it will suffer meaningful permanent damage and will not return to its original shape (e.g., length) upon release of the stress. A titanium wire will typically possess an elastic limit as above described of only about one percent (1.0%). The nickel-titanium alloy employed in the present invention, on the other hand, will exhibit an elastic limit of at least three percent (3%) and will most preferably exhibit an elastic limit of about eight percent (8%). Should the nickel-titanium wire be released from stress prior to reaching its elastic limit, it will return to, or at least very close to, its original shape.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A fishing rod comprising an elongate rod having at least a longitudinal portion thereof formed of a superelastic material selected from the group consisting of superelastic metals and superelastic metal alloys.

2. The fishing rod of claim 1 wherein:
said longitudinal portion is a first longitudinal segment of said elongate rod and
said elongate rod further includes at least a second longitudinal segment which is not formed of said superelastic material.

3. The fishing rod of claim 2 wherein said first longitudinal segment is removably attachable to said second longitudinal segment.

4. The fishing rod of claim 2 wherein said first longitudinal segment is a distal end segment of said elongate rod.

5. The fishing rod of claim 1 wherein all of said elongate rod is formed of said superelastic material.

6. The fishing rod of claim 1 further comprising at least one line guide, on said elongate rod, formed of a superelastic material selected from the group consisting of superelastic metals and superelastic metal alloys.

7. The fishing rod of claim 1 wherein:
said longitudinal portion is a first longitudinal segment of said elongate rod and
said elongate rod further comprises at least one additional longitudinal segment to which said first longitudinal segment is removably attachable,
wherein said additional longitudinal segment is formed of a superelastic material selected from the group consisting of superelastic metals and superelastic metal alloys.

8. The fishing rod of claim 1 wherein said superelastic material is a shape memory material.

9. The fishing rod of claim 1 wherein said superelastic material is a material in an austenitic state possessing superelasticity throughout an effective temperature range of use.

10. The fishing rod of claim 9 wherein said effective temperature range of use is a range extending from a temperature of about −25° to a temperature of about 40° C.

11. The fishing rod of claim 9 wherein said superelastic material is a nickel-titanium alloy.

12. The fishing rod of claim 11 wherein said nickel-titanium alloy consists essentially of nickel in an amount in the range of from about 55 to about 56 parts by weight and titanium in an amount in the range of from about 44 to about 45 parts by weight.

13. The fishing rod of claim 1 wherein said superelastic material has an elastic recovery value of greater than 50%.

14. The fishing rod of claim 9 wherein said superelastic material has an elastic recovery value of at least 90%.

15. The fishing rod of claim 1 wherein said superelastic material has an elastic limit of greater than 3%.

16. The fishing rod of claim 15 wherein said elastic limit is about 8%.
